(19) United States
(12) Patent Application Publication
(10) Pub. No.: US 2026/0180829 A1
(43) Pub. Date: Jun. 25, 2026

(54) SYSTEMS AND METHODS FOR DEMODULATION REFERENCE SIGNAL OVERHEAD REDUCTION

(71) Applicant: InterDigital Patent Holdings, Inc., Wilmington, DE (US)

(72) Inventors: Ahmet Serdar Tan, London (GB); Yugeswar Deenoo Narayanan Thangaraj, Chalfont, PA (US); Mohamed Salah Ibrahim, Chesterbrook, PA (US); Mihaela Beluri, Jericho, NY (US)

(73) Assignee: InterDigital Patent Holdings, Inc., Wilmington, DE (US)

(21) Appl. No.: 18/989,448

(22) Filed: Dec. 20, 2024

(51) Int. Cl. H04L 25/02; H04L 1/00; H04L 5/00

(52) U.S. Cl. CPC H04L 25/0224; H04L 1/0061; H04L 5/0048

(57) ABSTRACT

A wireless transmit/receive unit (WTRU) may receive configuration information, for example for a plurality of demodulation reference signals (DMRSs). The plurality of DMRSs (e.g., each of the plurality of DMRSs) may include a respective density. The densities may be different densities. The WTRU may receive a first DMRS of the plurality of DMRSs, for example based on the configuration information. The WTRU may predict a first channel, for example based on the first DMRS. The WTRU may send an indication of the predicted first channel to a network.

### BACKGROUND

Coherent demodulation of signals transmitted over the radio interface may require knowledge of the wireless channel. A channel estimation process at the receiver in NR may rely on the transmission of physical channels accompanied with demodulation reference signals (DMRS). DMRSs may be generated using pseudo-random sequences based on systems parameters known to the receiver. A configuration of the DMRS may include one or more of density and pattern in the resource grid, duration, starting symbol (e.g., front-loaded DMRS), and/or cover codes, for example to differentiate between antenna ports sharing the same time/frequency resources (e.g., for single-user and multi-user MIMO cases).

In the channel estimation and equalization process, the receiver may receive the DMRS as configured by the network. The receiver may estimate the effective channels, for example corresponding to the known DMRS symbols and/or apply interpolation and/or exploration operations to estimate the missing channel values for all resource elements in the grid. The receiver may design an equalizer based on the channel estimation and/or equalize the received data symbols.

### SUMMARY

A wireless transmit/receive unit (WTRU) may receive configuration information, for example for a plurality of demodulation reference signals (DMRSs). The plurality of DMRSs (e.g., each of the plurality of DMRSs) may include a respective density. The densities may be different densities. The WTRU may receive a first DMRS of the plurality of DMRS, for example based on the configuration information. The WTRU may predict a first channel, for example based on the first DMRS. The WTRU may send an indication of the predicted first channel to a network.

The WTRU may determine a pre-channel estimation, for example based on the first DMRS of the plurality of DMRSs. The WTRU may predict the first channel based on the pre-channel estimation. The WTRU may receive first symbols from the network. The WTRU may determine a post-channel estimation, for example based on the first symbols. The WTRU may predict the first channel based on the post-channel estimation. The WTRU may receive first data symbols from the network. The WTRU may equalize the one or more of the first data symbols based on the predicted first channel. The WTRU may decode the equalized (e.g., first) data symbols to obtain bits and/or convert the bits to second symbols. The WTRU may determine a post-channel estimation based on one or more of the first symbols and/or on the second symbols.

The WTRU may send feedback to the network. The feedback may be associated with the plurality of DMRSs and/or may include an indication of a difference and/or distance metric between a predicted channel and a post-channel estimation. The feedback associated with the predicted first channel and/r include an indication of a difference and/or distance metric between a pre-channel estimation and the predicted first channel. The indication may additionally, or alternatively, include an indication of whether the difference and/or distance metric between a pre-channel estimation and the predicted first channel exceeds a threshold. The WTRU may perform a cyclic redundancy check (CRC). The WTRU may determine that the CRC has failed and/or predict the first channel based on a pre-channel estimation. The WTRU may determine that the CRC has passed and/or predict the first channel based on a post-channel estimation.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram of an example DMRS procedure.

FIG. 3 is a diagram of another example DMRS procedure.

### DETAILED DESCRIPTION

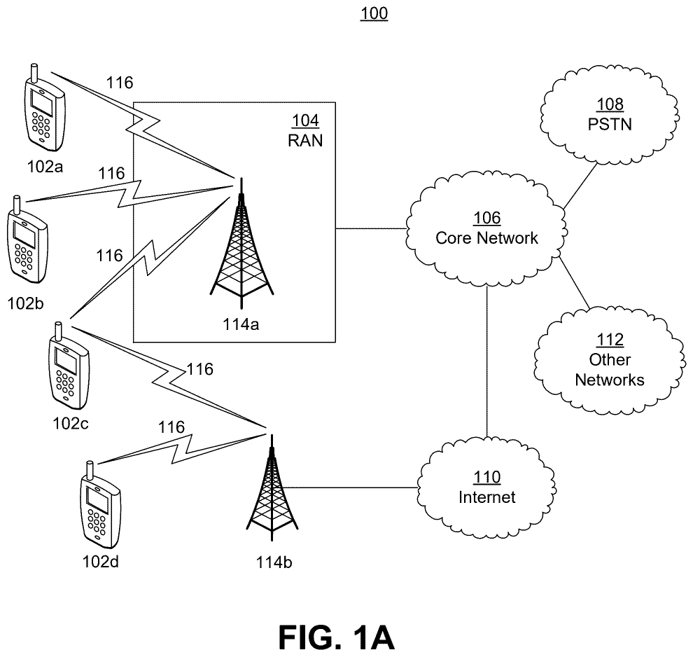

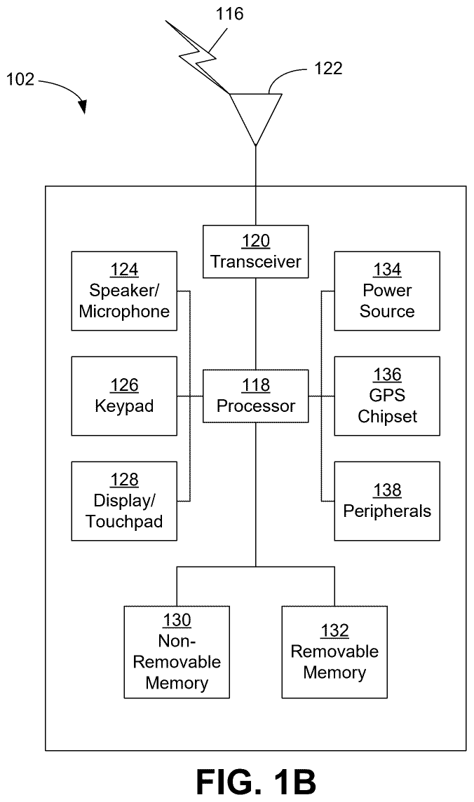

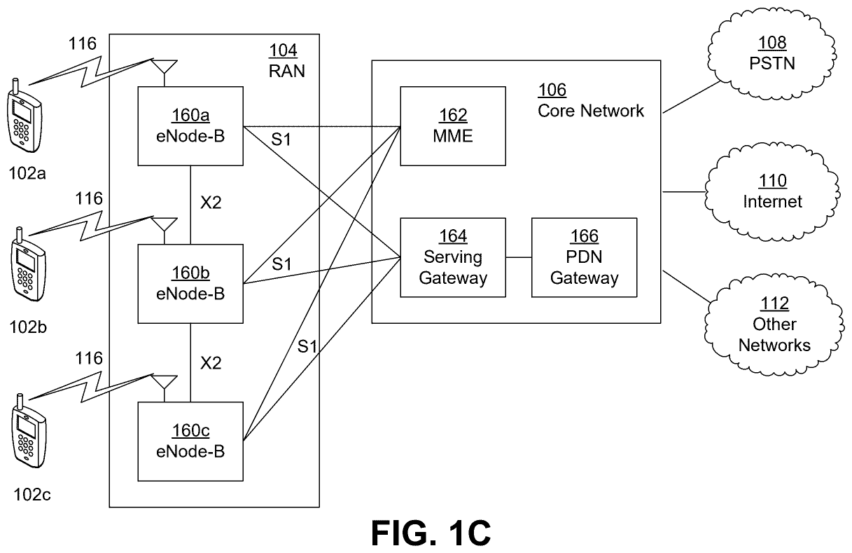

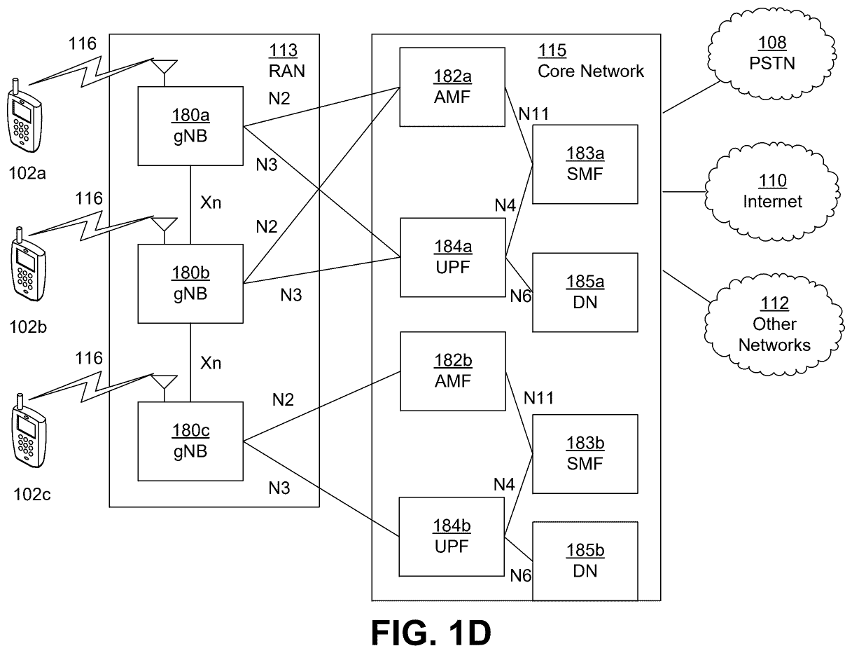

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may be configured to receive a reference signal, for example a, DMRS. The reference signal may have a varying density pattern in time and/or frequency. The WTRU may perform downlink channel processing, for example one or more of demodulation and/or equalization, etc. The WTRU may perform downlink channel processing based on (e.g., as a function of) one or more of a pre-channel estimation (e.g., based on the reference signal), post-detection channel estimation (e.g., based on successfully decoded data symbols), and/or channel prediction (e.g., based on AIML model, based on non-AIML based prediction etc.). The WTRU may transmit one or more monitoring reports, for example associated with the varying density pattern of RS and/or performance of channel prediction operation. The WTRU may transmit an indication of least one (e.g., preferred and/or recommended) DMRS parameter, for example based on a DMRS pattern. The DMRS pattern may be one of a plurality of hypothetical DMRS patterns, for example that meet a preconfigured criteria.

Systems and methods herein may provide DMRS overhead reduction, for example using advanced receiver processing. Using DMRS for channel estimation and/or equalization may result in overhead cost and/or reduce overall throughput, for example for high mobility scenarios and/or high number of layers/users. Systems and methods herein may reduce the DMRS overhead with advanced WTRU processing, for example by determining optimal DMRS density and/or DMRS pattern(s).

A WTRU may receive DMRS based on a temporal density pattern. The WTRU may equalize, for example based on a channel prediction computed using decoded data symbols. The WTRU may report a channel prediction metric. The WTRU may be configured to (e.g., capable of) channel prediction with post-channel estimation. The WTRU may receive configuration information. The configuration information may include and/or be for one or more of multiple DMRS configurations (e.g., DMRS_config #1, DMRS_config #2, etc.), rules to determine a DMRS configuration, channel prediction performance metrics for feedback, channel prediction model configuration, model monitoring metrics, a reporting periodicity for prediction performance metric(s), a reporting periodicity for model monitoring, DMRS prediction timing, and/or DMRS prediction reset. The rules to determine the DMRS configuration may enable a temporal (e.g., gradually reducing density) DMRS pattern.

The WTRU may receive a (e.g., first) DMRS, rₜ, for example based on a (e.g., first) DMRS configuration. The DMRS configuration (e.g., configuration information) may be based on and/or include one or more of a slot number, a time difference between a current and a previous slot in which the PDSCH was received and/or a corresponding DMRS configuration, an indication in DCI to detect the DMRS configuration, and/or an indication of whether an associated transmission is a transmission of new data or a retransmission. The indication in DCI may be implicit (e.g., reuse DAI) or explicit (e.g., a new indication).

The WTRU may receive a (e.g., first) set of associated transmission data symbols, yₜ. The WTRU may determine (e.g., compute) a (e.g., first) predicted channel Hₜ^{pred}, for example based on the DMRS prediction timing and/or the received (e.g., first) DMRS. For example if DMRS prediction timing t=0 and/or there is a DMRS prediction reset for the (e.g., first) DMRS configuration, the WTRU may determine that the first predicted channel Hₜ^{pred} is the same as a first DMRS-based channel estimation (e.g., H₀^{pre} determined from the received first DMRS). For example if DMRS prediction timing t>0 for the (e.g., first) DRMS configuration, the WTRU may compute the (e.g., first) predicted channel, Hₜ^{pred}. The WTRU may determine (e.g., compute) the (e.g., first) predicted channel using one or more of the (e.g., first) DRMS-based channel estimation, Hₜ^{pre} and/or one or more (e.g., first) post-channel estimates (e.g., HHₜ₋ₓ^{post}, 1≤x≤t).

The WTRU may compute a (e.g., first) set of equalized received symbols, yₜ^{eq}, for example based on one or more of the received DMRS, the received data symbols, and/or the (e.g., first) predicted channel Hₜ^{pred}. The WTRU may decode a (e.g., first) set of data bits aₜ, for example based on the first set of equalized received symbols.

The WTRU may compute a (e.g., second) post-detection channel estimate, Hₜ^{post}, for example based on the decoded (e.g., first) set of data bits and/or whether the decoding passes CRC. The WTRU may compute a (e.g., first) set of decoded symbols, sₜ, using the (e.g., first) set of decoded data bits aₜ, for example if CRC pass after decoding. Additionally, or alternatively, the WTRU may encode a codeword, for example depending on the channel coding scheme. The WTRU may compute the (e.g., second) post-detection channel estimate Hₜ^{pre} using the (e.g., first) set of decoded data symbols sₜ and/or (e.g., first) set of received data symbols yₜ, for example if CRC pass after decoding.

The WTRU may use the (e.g., first) set of decoded data bits aₜ and/or compute the (e.g., second) post-detection channel estimate Hₜ^{post}, for example if CRC fail after decoding (e.g., similar to if CRC had passed). The WTRU may select a subset of the (e.g., first) set of decoded data bits, aₜ′, by excluding bits with high error probability and/or compute the (e.g., second) post-detection channel estimate Hₜ^{post} using the subset of the (e.g., first) set of decoded data bits and/or the procedure described for when CRC passes, for example if CRC fail after decoding. The WTRU may set the (e.g., second) post-detection channel estimate to be a (e.g., previously computed) (e.g., first) post-detection channel estimate, for example if CRC fail after decoding. (e.g., computed for a case where CRC passed). For example, Hₜ^{post}←Hₜ₋₁^{post}. The WTRU may determine that there is no (e.g., second) post-detection channel estimate, for example if CRC fail after decoding.

The WTRU may compute a prediction and/or monitoring metric, for example based on one or more (e.g., (e.g., first) predicted channel(s) Hₜ^{pred} and/or one or more (e.g., (e.g., second) post-detection channel estimate(s) Hₜ^{post}. The prediction and/or monitoring metric may include a distance metric between a predicted channel and a post-channel estimate. The distance metric may include one or more of a cosine similarity (e.g., SGCS metric), a mean squared error (e.g., NMSE metric), and/or a mean absolute difference. For a number of layers greater than 1 for example, the WTRU may compute one or more of a distance metric per layer, a distance metric for a subset of layers, a differential distance metric per layer, and/or a distance metric based on the CRC failure per layer.

The WTRU may compute a metric, for example every P predicted channel instance. The metric may include one or more of a measure of distances between Hₜ^{pre} and Hₜ^{pred}, a measure of distances between Hₜ^{pre} and Hₜ^{post}, a mean of distance (e.g., Dist(·)) for P historical instances, a standard deviation (stdev) of distance (e.g., Dist(·)) for P historical instances, and/or a distance (e.g., Dist(·)) for each P historical instances.

The WTRU may transmit a prediction and/or monitoring metric report, for example based on a configured reporting periodicity. The report may include one or more of a computed metric, an indication of whether the distance metric meets configured criteria, an indication (e.g., report 1 (0)) when the distance metric is above or below a (e.g., configured) threshold, and/or a distance metric. For example the report may include a distance metric when the distance metric is above a threshold. The WTRU may report a value indicating the failure (e.g., inf, or report nan), for example if there is a CRC fail. If the number of layers greater than 1 for example, the WTRU may report one or more of a distance metric per layer, a differential distance between layers, a distance metric for a subset of layers. The WTRU may report based on (e.g., depending on) CRC failures per layer.

Systems and methods may reduce DMRS overhead using decoded data symbols for equalization. The WTRU may determine a DMRS pattern with a lowest density, for example using decoded data symbols. A WTRU configured to (e.g., capable of) perform post-channel estimation and/or hypothetical DMRS generation may receive configuration information. The configuration information may include and/or be for a configuration on hypothetical DMRS generation. The configuration on hypothetical DMRS generation may include one or more of a set of hypothetical DMRS patterns, rule(s) for hypothetical DMRS generation, and/or an indication to determine the hypothetical DMRS at the WTRU. The rule(s) for hypothetical DMRS generation may include one or more of maximum/minimum density, maximum/minimum number of DMRS, maximum/minimum spacing between DMRS in the grid, and/or maximum/minimum number of DMRS patterns.

The configuration information may include and/or be for a configuration on the selection of DMRS parameters (e.g., density and/or pattern). The configuration on the selection of DMRS parameters may include rule(s) for determining the DMRS parameters and/or a distance metric for DMRS parameter selection. The rule(s) for determining the DMRS parameters may include one or more of a threshold on maximum allowed distance metric, a max/min density, and/or be based on historical BLER thresholds. For example, the WTRU may be configured with a rule to report a higher DMRS density for BLER higher than the threshold.

The WTRU may generate hypothetical DMRS for pre-channel estimation, for example based on one or more of configured/indicated set of DMRS patterns, rule(s) for hypothetical DMRS generation, a post-channel estimate, and/or based on a future time index. For example, the WTRU may use the configured/indicated set of DMRS patterns to generate the hypothetical DMRS. The WTRU may generate set of hypothetical DMRS patterns that satisfy all the configured rules. The WTRU may determine a set of hypothetical DMRS by processing the transmitted and/or received symbols, for example for the post-channel estimate. For example, the WTRU may compute the RE(s) with highest degree of change. The WTRU may predict the channel for a future time index t+k and/or compute the hypothetical DMRS for the future time index.

The WTRU may compute post-channel estimation using the decoded data symbols and/or received data symbols. The WTRU may compute the distance between post-detection channel estimate and all pre-channel estimates. The WTRU may determine the DMRS parameters based one or more of the DMRS pattern and/or density that satisfies the distance threshold with minimum density, and/or the DMRS pattern and/or density with lowest distance metric. The WTRU may report the (e.g., selected) DMRS parameters by reporting a DMRS density and/or pattern. For example, the WTRU may report the DMRS density and/or pattern after every post-channel estimation. The WTRU may report the DMRS density and/or pattern (e.g., only) if a computed density is higher or lower than the previous reported density. The WTRU may report the DMRS density and/or pattern based on a BLER target. Systems and methods as herein may result in optimal DMRS density/pattern selection via hypothetical DMRS generation at the WTRU.

Systems and methods for DMRS overhead reduction are disclosed herein. A WTRU may be configured to (e.g., capable of) performing post-detection channel estimation, for example to provide WTRU assistance for a dynamic DMRS density operation. The WTRU may receive configuration information associated with determining and/or reporting metrics for a dynamic low-density DMRS operation. The configuration information may include one or more of a set of configurations to determine the DMRS configuration, rule(s) to determine the DMRS configuration, monitoring metric(s), and/or reporting configuration(s). The WTRU may be configured semi-statically, for example via RRC configuration (e.g., when the NW switches the DMRS configuration. Additionally, or alternatively, the WTRU may be configured dynamically, for example via MAC CE or DCI (e.g., when the NW switches the DMRS configuration).

DMRS configurations and/or rules to determine the DMRS configuration are disclosed herein. The WTRU may receive multiple DMRS configurations, for example with different densities across time and/or frequency resources. A (e.g., each) configuration may include one or more of a configuration in a frequency domain, a configuration in a time domain, a pattern configuration, and/or an orthogonal cover code (OCC) indicator. A configuration in frequency domain may indicates the DMRS location in the frequency domain (e.g., sub-carrier locations within an RB and/or a group of RBs). The configuration may be indicated as an index from a list of pre-defined (e.g., specified) frequency-domain configurations, and/or as a list of sub-carrier indices within a RB or a group of RBs. The configuration in the time domain may indicate the DMRS location in the time domain (e.g., OFDM symbol locations), for example within a RB/slot or a group of RB/slots. The indication may include an index from a list of pre-defined time-domain configurations (e.g., one symbol DMRS, or multiple symbol DMRS), and/or a list of OFDM symbol indices within a RB/slot or a group of RB/slots. The pattern configuration may indicate the RE location of the DMRS in time-frequency domain, for example within a RB or a group of RBs. The indication may include an index from a list of pre-defined time-frequency domain (e.g., 2D) patterns, and/or a list of time-frequency index pairs of DMRS REs within a RB/slot or a group of RB/slots. The OCC indicator may be used to orthogonalize the DMRS resources mapped to the same REs, for example for the case of multi-layer transmission.

The WTRU may receive configuration information (e.g., a configuration) for the channel prediction model. The configuration information may include one or more of a number of post-detection channel estimates to use for predicting the channel for equalization purposes, and/or rule(s) for predicting the channel for equalization purposes. The rules for predicting the channel for equalization purposes may be for when the post-detection channel is not available. For example, for first predicted channel (e.g., at t=0), the WTRU may select the DMRS based estimate (e.g., the “pre”-channel). For example when the data fails to be received correctly (e.g. fails the CRC), the WTRU may determine the predicted channel using the DMRS based estimate (e.g., the “pre”-channel) and/or the last post-detection channel estimate for which the CRC passed.

The WTRU may receive configuration information (e.g., a configuration) for the monitoring metrics, which for example may include metrics for channel prediction performance and/or model monitoring metrics. The configuration information may be of channel prediction performance metrics to feedback as WTRU assistance information for DMRS scheduling. The configuration information may include one or more of a metric type, channels being compared, an averaging window, an averaging type, a measurement type for multi-layer configurations, a measurement periodicity, and/or threshold(s) for channel prediction performance.

The metric type may include a distance (e.g., function) between two channels. The distance function may include a cosine similarity (CS, or generalized CS, or squared generalized cosine similarity (SGCS)), a mean squared error (MSE), a normalized mean squared error (NMSE), and/or mean of absolute difference. The configuration information may channels being compared. For example, the WTRU may be configured to report the distance between the predicted channel (e.g., used for equalization) and the post-detection channel estimate.

The configuration information may include an averaging window. The averaging window may indicate the length of the window for averaging the metrics. For example, the distance metrics may be averaged from the start of the current DMRS configuration, and/or may be averaged for the configured window length (e.g., for a sliding window measurement). Additionally, or alternatively, the window length may be set to 1 (e.g., no temporal averaging). The configuration information may include an averaging type. The WTRU may be configured to determine different (e.g., separate) metrics for the successful reception (e.g., passing the CRC) and for unsuccessful reception (e.g., failed CRC).

The configuration information may include a measurement type for multi-layer configurations. For example, the WTRU may be configured to determine the distance metrics for each layer, and/or to determine the distance averaged for all transmitted layers. The configuration information may include a measurement periodicity. For example, the WTRU may be configured to perform the channel prediction performance every P prediction instances. A prediction instance may include one or more of a slot, TTI, and/or a group of slots/TTIs. The configuration information may include threshold(s) for channel prediction performance, for example a SGCS threshold and/or a NMSE threshold.

The configuration information of model monitoring metrics may include one or more of distance function(s) for the metric to be reported (e.g., SGCS and/or NMSE), and/or channels being compared. For example when the channel prediction performance does not meet the configured threshold, the WTRU may report the distance metric between the “pre” channel estimate (e.g., the channel estimate based on the received DMRS) and the post-detection channel estimate corresponding to the same observation interval (e.g., slot, TTI, etc.).

Configurations for reporting metrics and WTRU assistance information are disclosed herein. The WTRU may receive configuration information (e.g., a configuration) for reporting the WTRU assistance information for dynamic DMRS density operation and/or the model monitoring metrics. The configuration information may include one or more of a report type, metric(s) to be reported (e.g., the distance function, which may be SGCS, or NMSE), a report periodicity, resources for reporting the calculated metrics and WTRU assistance information, rule(s) for the report.

The configuration information may include a report type. The report type may indicate whether the WTRU reports the computed distance metric, and/or whether the WTRU reports if the distance metric is above or below a (e.g., configured) threshold. The configuration information may include a report periodicity: for example, for periodic reports, the UE may be configured with the report periodicity, e.g., number of slots/TTIs/ms between consecutive reports. The configuration information may include resource(s) for reporting the calculated metrics and/or WTRU assistance information. The configuration information may include rule(s) for dropping the report, for example when reporting on PUSCH and higher priority CSI feedback is scheduled on the same resources. The WTRU may receive aperiodic report configuration(s), for example to report the calculated metric when configured conditions are met. The configured conditions may include one or more of a SGCS metric smaller than a configured threshold, and/or NMSE metric greater than a configured threshold.

Systems and method herein may reduce DMRS overhead. A WTRU may be configured with multiple DMRS configurations. The DMRS configurations may indicate (e.g., have) different densities across time and/or frequency resources (e.g., temporal DMRS pattern). The WTRU may receive a (e.g., first) set of DMRS, rₜ. A current DMRS pattern (e.g., DMRS pattern timing) may be determined based on one or more of a slot number, a time difference between a current and a previous slot in which the PDSCH was received, a temporal DMRS pattern with a non-increasing or decreasing density, an explicit indication of a DMRS pattern, and/or an implicit indication of a DMRS pattern. The WTRU may determine the current DMRS pattern based on the slot number, for example where the DMRS is received.

The WTRU may hold a counter on slot number, for example starting with 0 where a DMRS pattern from the temporal DMRS pattern is (e.g., first) received after the configuration by the network (NW). The WTRU may compute the time difference (e.g., in slots and/or milliseconds) between the current slot with DMRS reception and a previous slot with DMRS reception. The WTRU may (e.g., then) determine the current DMRS pattern based on the time difference and/or the configured temporal DMRS pattern. The temporal DMRS pattern may have non-increasing or decreasing density. The explicit indication of the DMRS pattern may be an indication within DCI, for example where the indication provides an identifier to the WTRU for the determination of current DMRS pattern based on the configured temporal DMRS pattern. The explicit indication to determine the configuration of the received DMRS may additionally or alternatively indicate (e.g., to the WTRU) an action taken by the NW on the previous transmission with a CRC fail. For example the action may include resetting the DMRS pattern and/or indicating an interim DMRS pattern. The implicit indication of the DMRS pattern may be based on an existing indication, for example such as the downlink assignment index (DAI). The WTRU may determine a current DMRS pattern based on the implicit indication and/or configured temporal DMRS pattern.

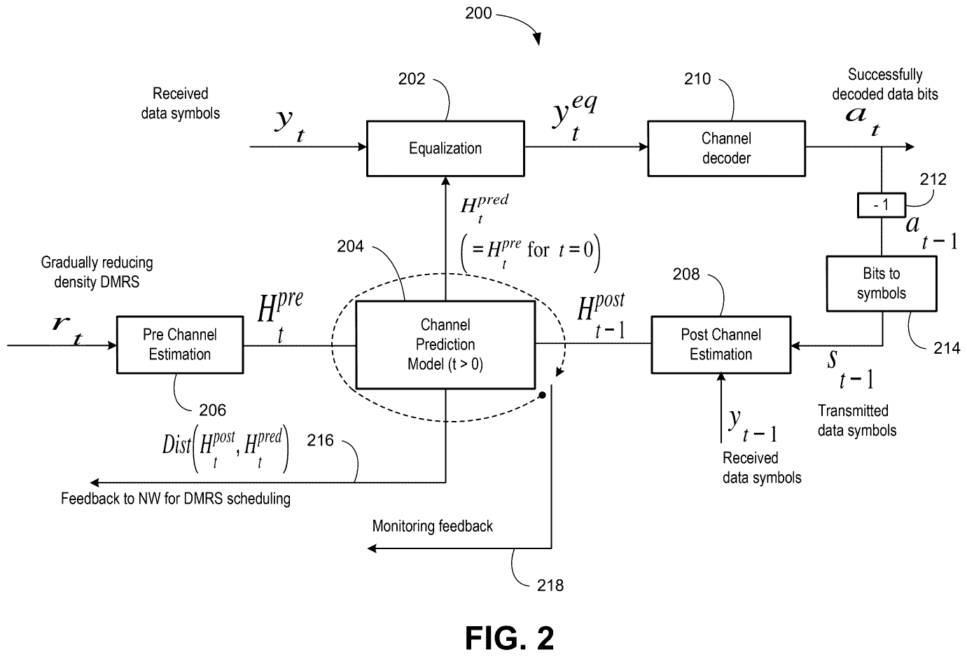

FIG. 2 is a diagram of an example DMRS procedure 200. The WTRU may receive a (e.g., first) set of associated transmission data symbols yₜ (e.g., for example for scheduled PDSCH resources). An associated (e.g., first) set of DMRS may be used for the equalization of the (e.g., first) set of PDSCH resources. The data symbols may follow any MCS index, and/or any associated resources, for example as indicated in the DCI.

As herein, the pre-channel estimate and pre-channel may refer to the DMRS based channel estimation. As herein, the terms post-channel estimate, post-channel and post-detection channel estimate, and post-detection channel may refer to channel estimation using decoded received symbols, for example through post-processing.

Systems and methods may utilize channel prediction for equalization. The WTRU may perform equalization at 202. A WTRU may be configured with an AIML prediction model, for example to predict the channel needed for data equalization. The terms AIML prediction model, AIML refinement model, and AIML model may be used to indicate the AIML model used for computing the channel used for demodulation. The AIML refinement model may be associated with a (e.g., first) input, Hₜ^{pre} and/or a (e.g., second) input, Hₜ₋₁^{post}.

At 204 the WTRU may receive input to a channel prediction model (e.g., AI/ML model). The (e.g., first) input may be associated with the estimated channel based on a received (e.g., first) DMRS (e.g., pre-channel estimate). For example at 206 the WTRU may perform a pre-channel estimation. The WTRU may perform the pre-channel estimation, for example at 206, based on DMRS received from the network.

The (e.g., second) input (e.g., to the channel prediction model at 204) may be associated with the post-detection channel estimate, for example based on post-processing of the decoded data symbols. For example at 208 the WTRU may perform post-channel estimation. The post-channel estimation (e.g., at 208) may be based on received data symbols (e.g., from the network) and/or transmitted data symbols. The (e.g., second) input may be lagged by at least one time unit (e.g., slot), for example as the post-processed channel from the previous transmission may be used for equalization of the data in the current transmission. The (e.g., second) input may be associated with one or more previous post-detection channel samples

$$( e . g . , {H}_{t - 1}^{post} … , {H}_{t - N}^{post} ) ,$$

for example where N is the number of previous post-detection channel samples. N may be configured by NW and/or determined by the WTRU. The (e.g., second) input may be obtained as a function of the equalized data symbols, denoted as

$${y}_{t}^{eq} .$$

For example at 210 the WTRU may utilize a channel decoder to decode data bits. At 212 a delay operation may be implemented. The output at 212 may be bits decoded at time t−1, as at time t the decoded bits may not be available yet. The (e.g., second) input may be obtained by processing the bits decoded at the previous time instance aₜ₋₁ from the channel decoder through converting the decoded bits to symbols, sₜ₋₁ at 214. The symbols (e.g., transmitted data symbols) may (e.g., then) be input for post-channel estimation (e.g., at 208).

Additionally, or alternatively, the (e.g., second) input may be obtained by (e.g., then) equalization that uses the successfully decoded symbols along with the received symbols yₜ to derive the post-detection channel estimate

$${H}_{t}^{post} .$$

The post-detection channel

$${H}_{t}^{post}$$

may be the actual channel, for example if the CRC check passes. The post-detection channel

$${H}_{t}^{post}$$

may be constructed only for the bits associated with the code blocks that pass the CRC check in some examples. The derived

$${H}_{t}^{post}$$

may (e.g., then) be used as the (e.g., second) input, for example at time t+1 to the AIML model to compute the predicted channel

$${H}_{t + 1}^{pred} .$$

The WTRU may compute a (e.g., first) predicted channel

$${H}_{t}^{pred} ,$$

for example based on the DMRS pattern timing and/or the received DMRS. For example, if the DMRS pattern timing is t=0 and/or there is a prediction reset for the (e.g., first) DMRS configuration, the WTRU may (e.g., then) determine the (e.g., first) predicted channel

$${H}_{0}^{pred}$$

(e.g., only) based on the (e.g., first) input

$${H}_{0}^{pre}$$

derived from the received (e.g., first) DMRS. At t=0 for example, the WTRU may use

$${H}_{0}^{pred} = {H}_{0}^{pre} .$$

The WTRU may determine the reset event(s) for the (e.g., first) DMRS configuration. The WTRU may reset to the (e.g., first) DMRS configuration, for example if the channel prediction model accuracy is below a threshold. If the DMRS pattern timing t>0 for example, the WTRU may compute the (e.g., first) predicted channel

$${H}_{t}^{pred}$$

as a function of the (e.g., first) input

$${H}_{t}^{pre}$$

and/or the (e.g., second) input

$${H}_{t - x}^{post} ,$$

for 1≤x≤N. N may represent the number of post-processed estimated channel samples.

Systems and methods may utilize equalization and/or post-channel estimation. The WTRU may perform equalization with a predicted channel. The WTRU may compute the (e.g., first) set of equalized received symbols,

$${y}_{t}^{e q} ,$$

for example based on a (e.g., first) set of DMRS, rₜ, the received data symbols yₜ and/or the (e.g., first) predicted channel

$${H}_{t}^{pred} .$$

The WTRU may use a configured and/or pre-determined equalization method. For example the configured and/or pre-determined equalization method may include one or more of a zero forcing (ZF) equalizer and/or a minimum mean square error (MMSE) equalizer. The equalizer may be calculated based on the predicted channel

$${H}_{t}^{pred} .$$

The WTRU may decode the data bits via a channel decoder, for example after equalization. For example inputs to the channel decoder may include one or more of equalized received symbols,

$${y}_{t}^{e q} ,$$

log likelihood ratios computed using equalized received symbols,

$${y}_{t}^{e q} ,$$

and/or hard decisions (e.g., binary values) determined based on the decision regions and/or received equalized symbols

$${y}_{t}^{e q} .$$

The output of the decoding process (e.g., a (e.g., first) set of bits aₜ), may be applied to a cyclic redundancy check (CRC) process. The CRC process may provide information on the success of channel decoding for the associated data transmission.

The WTRU may perform post-channel estimate(s) and/or error handling. For example if the associated decoded data transmission bits pass the CRC (e.g., successful data transmission), the WTRU may compute the associated (e.g., first) set of the decoded transmitted symbols and/or compute a (e.g., second) post-detection channel estimate. The WTRU may compute the associated (e.g., first) set of the decoded transmitted symbols, sₜ based on the decoded (e.g., first) set of bits. The WTRU may compute transmitted symbols using the (e.g., first) set of decoded bits by re-computing the PDSCH processes for the associated transmission (e.g., including one or more of channel encoding, rate matching, symbol modulation, and/or mapping to REs, etc.). The associated set of decoded transmitted symbols may correspond to scheduled resource elements (REs) of the associated PDSCH transmission.

The WTRU may compute the (e.g., second) post-detection channel estimate,

$${H}_{t}^{post} ,$$

based on the (e.g., first) set of the decoded transmitted symbols, sₜ and/or the (e.g., first) set of received data symbols yₜ. For the post-channel estimate for example, the (e.g., first) set of decoded transmitted symbols from the resources assigned to the associated transmission may be associated with (e.g., constitute) hypothetical DMRS. The WTRU may use (e.g., all) decoded data symbols to determine the post-detection channel estimate,

$${H}_{t}^{post} .$$

The post-detection channel estimate may indicate (e.g., represent) the highest quality channel estimate for the associated transmission.

If the associated decoded data transmission bits fail the CRC for example (e.g., unsuccessful data transmission), the WTRU may compute the associated (e.g., first) set of the decoded transmitted symbols, select a subset of the (e.g., first) set of decoded data bits, set the current post estimate to be a previously computed post-channel estimate, and/or determine that there is no post-channel estimate for the current associated transmission.

The WTRU may compute the associated (e.g., first) set of the decoded transmitted symbols, sₜ based on the decoded (e.g., first) set of bits, for example regardless of the CRC outcome. The WTRU may (e.g., then) proceed as if CRC passed. The WTRU may select a subset of the (e.g., first) set of decoded data bits, aₜ′, by excluding bits with estimated high error probability during the channel decoding process. The WTRU may (e.g., then) compute a subset of the decoded transmitted symbols, sₜ′, for example based on the subset of decoded bits. The WTRU may (e.g., then) compute a (e.g., second) post-detection channel estimate,

$${H}_{t}^{post} ,$$

for example based on the subset of (e.g., first) set of the decoded transmitted symbols,

$${s}_{t}^{′}$$

and/or the associated subset of (e.g., first) set of received data symbols

$${y}_{t}^{′} .$$

The WTRU may additionally or alternatively apply extrapolation, for example to fill up the missing channel coefficients due to the use a subset of transmitted symbols. The WTRU may set the current post estimate, for example to be a previously computed post-channel estimate. The previous post-channel estimate may have been computed for a case with CRC passed. For example if the current CRC fails and the previous CRC passed, then

$${H}_{t}^{post} ← {H}_{t - 1}^{post} .$$

The WTRU may set any previous post-detection channel estimate for the current post-channel estimate.

The WTRU may compute the post-channel estimate

$${H}_{t - 1}^{post}$$

based on a (e.g., first) DMRS configuration/pattern and received (e.g., first) set of symbols. The WTRU may compute a DMRS-based pre-channel estimation

$${H}_{t}^{pre}$$

based on a (e.g., second) DMRS configuration/pattern. Then, the WTRU may compute a channel prediction

$${H}_{t}^{pred}$$

based on the post-channel estimate

$${H}_{t - 1}^{post}$$

and pre-channel estimate

$${H}_{t}^{pre} .$$

Then, the WTRU uses

$${H}_{t}^{pred}$$

for the equalization or received symbols. This iterative process enables the WTRU to use lower density DMRS pattern within the (e.g., second) DMRS configuration/pattern compared to the (e.g., first) DMRS configuration/pattern.

The WTRU may compute prediction and/or monitoring metrics. The WTRU may be configured to determine and/or report a prediction/monitoring metric associated with the channel prediction model. The prediction metric may be used by the NW to adapt the DMRS density. For example when the prediction model accuracy is high, the post-processed estimated channel may have a significant impact on the performance of the CSI prediction model. The NW may (e.g., therefore) reduce the DMRS density (e.g., reduce the DMRS overhead) associated with deriving the pre-estimated channel, which may for example result in more efficient communication. The channel prediction model may operate for one or more of each layer, each DMRS resource-element (RE), and/or for each receive antenna element. The prediction output for an (e.g., each) inference may be a scalar (e.g., a value/layer/RE/Rx-antenna), a vector, and/or a matrix. The vector may have a dimension of the number of Rx antennas. The matrix may have a dimension of the number of Rx antennas times the number of DMRS REs per layer.

The WTRU may compute the prediction metric based on one or more inputs. The one or more inputs may include one or more of the output of the prediction model

$${H}_{t}^{pred}$$

at time t, the pre-channel estimate

$${H}_{t}^{pre}$$

at time t, and the post-detection channel estimate

$${H}_{t}^{post} .$$

For example, a (e.g., first) prediction metric may represent a distance metric between

$${H}_{t}^{pred} and {H}_{t}^{post} .$$

The (e.g., first) prediction metric may indicate how far the predicted channel is from the true/perfect channel obtained from post-detection error-free (i.e., CRC passed) decoded data symbols. For example, a (e.g., second) prediction metric may represent a distance metric between

$${H}_{t}^{pred} and {H}_{t}^{p r e} .$$

The (e.g., second) prediction metric may indicate the amount of error in the pre-channel estimate relative to the predicted channel used for actual equalization.

In some examples, the prediction metric may be a coarse metric and/or a granular metric. A coarse metric may represent an average distance metric across one or more (e.g., all) layers, receive antennas, and/or DMRS REs. A granular metric may be a distance metric computed for one or more (e.g., each) layer, (e.g., each) receive antenna element, and/or (e.g., each) RX antenna element (e.g., one value/layer/receive antenna/DMRS RE). The WTRU may be configured to determine and/or report granular values for a (e.g., first) subset of layers. The WTRU may be configured to determine coarse values for a (e.g., second) subset of layers. In some examples, the WTRU may be configured to determine the distance metric for a subset of layers which pass the CRC check, for example only the subset of layers which pass the CRC check.

The distance metric may include one or more of a cosine similarity, a normalized mean square error, a mean absolute difference, and/or a number of elements with an absolute difference greater than a configured threshold. The cosine similarity may be determined by,

$${g}_{1} ( {h}_{t}^{p o s t} , {h}_{t}^{p r e d} ) = \frac{{\vert {h}_{t}^{p o s t *} {h}_{t}^{p r e d} \vert}^{2}}{‖ {h}_{t}^{p o s t} ‖ ‖ {h}_{t}^{p r e d} ‖} ,$$

where

$${h}_{t}^{p o s t} and {h}_{t}^{p r e d}$$

represents the Nᵣ×1 post-detection channel estimate and the predicted channel for a specific layer at specific DMRS RE location, respectively. The WTRU may be configured to determine and report the average cosine similarity across all layers and/or DMRS RE locations. The normalized mean square error may be determined by,

$${g}_{2} ( {h}_{t}^{p o s t} , {h}_{t}^{p r e d} ) = \frac{{‖ {h}_{t}^{p o s t *} {h}_{t}^{p r e d} ‖}^{2}}{{‖ {h}_{t}^{p o s t} ‖}^{2}} .$$

The mean absolute difference may be determined by,

$${g}_{3} = \frac{{‖ {h}_{t}^{p o s t} - {h}_{t}^{p r e d} ‖}_{1}^{2}}{{N}_{r}} ,$$

where ∥·∥₁ is the L−1 norm. Additionally, or alternatively, the distance metric may include the number of elements with absolute difference greater than a configured threshold. The WTRU may be configured to report the distance metric as the number of elements with absolute error greater than a configured threshold, for example instead of computing the mean absolute difference.

Systems and methods may include a frequency of computing the prediction/monitoring metric. The WTRU may compute the distance metric, for example every P predicted channel instances. The value of P may be configured (e.g., averaging window). The WTRU may compute the distance metric, for example if the number of NACKs exceeds a (e.g., configured) threshold. The WTRU may compute the distance metric, for example if the DMRS density is below a (e.g., configured) value/threshold. The WTRU may be configured to compute and/or report one or more of the distance between

$${h}_{t}^{p o s t} and {h}_{t}^{p r e d}$$

and/or the distance between

$${h}_{t}^{pre} and {h}_{t}^{post} .$$

In some examples the WTRU may be configured to compute and/or store the metric distance for P historical instances. The WTRU may be configured to report the individual distance values for a (e.g., each) historical instance. Additionally, or alternatively, the WTRU may be configured to compute the one or more distance statistics for P historical instances. The statistics may include one or more of a mean, variance, standard deviation, and/or median, etc.

The WTRU may report on the distance metric for channel prediction and performance monitoring. The WTRU may be configured to receive a reference signal (e.g., DMRS) with varying density pattern in time and/or frequency. The WTRU may perform downlink channel processing (e.g., demodulation, and/or equalization, etc.) based on (e.g., as a function of) one or more of a pre-channel estimation (e.g., based on the reference signal), post-detection channel estimation (e.g., based on successfully decoded data symbols), and/or channel prediction (e.g., based on AIML model, based on non-AIML based prediction etc.). The WTRU may transmit one or more monitoring reports, for example associated with the varying density pattern of RS and/or performance of channel prediction operation. The WTRU may transmit an indication of least one (e.g., preferred and/or recommended) DMRS parameter, for example based on a DMRS pattern. The DMRS pattern may be one of a plurality of hypothetical DMRS patterns, for example that meet a preconfigured criteria.

A channel prediction may take as input one or more of the current and/or historical pre-channel estimation, and/or current and/or historical post-channel estimation, etc. The WTRU may be configured to transmit one or more reports associated with the varying density pattern of RS and/or performance of channel prediction operation. The report may be referred to as monitoring report herein. The WTRU may be configured to include one or more monitoring metrics, for example as described herein, in the monitoring report.

The WTRU may transmit a (e.g., first) feedback type and a (e.g., second) feedback type, wherein the (e.g., first) feedback type may be associated with varying density pattern of RS and the (e.g., second) feedback type may be associated with the channel prediction performance. For example the WTRU may transmit the (e.g., first) feedback type to the network at 216. The WTRU may transmit the (e.g., second) feedback type to the network at 218. In a solution, the (e.g., first) feedback type may include a (e.g., first) monitoring metric—wherein the (e.g., first) monitoring metric may be a function of distance/difference between the post-detection channel estimation and predicted channel. In a solution, the (e.g., second) feedback type may include a (e.g., second) monitoring metric—wherein the (e.g., second) monitoring metric may be a function of distance/difference between the post-channel estimation and pre-channel estimation. In another solution, the (e.g., second) monitoring metric may be a function of distance/difference between pre-channel estimation and predicted channel. In a solution, the (e.g., first) feedback type and (e.g., second) feedback type may be included in the same monitoring report. In another solution, the (e.g., first) feedback type and (e.g., second) feedback type may be included in the in a different/separate monitoring report.

The WTRU may be configured to indicate if the monitoring metric meets one or more configured criteria. For example, the WTRU may indicate a (e.g., first) value (e.g., 0) when a monitoring metric is below a preconfigured threshold. For example, the WTRU may indicate a (e.g., second) value (e.g., 1) when a monitoring metric is above a preconfigured threshold. For example, the WTRU may indicate a (e.g., first) value (e.g., 0) when the (e.g., first) monitoring metric is below a (e.g., second) monitoring metric by a preconfigured threshold. For example, the WTRU may indicate a (e.g., second) value (e.g., 1) when the (e.g., first) monitoring metric is above a (e.g., second) monitoring metric by a preconfigured threshold.

The WTRU may be configured to report a preconfigured reserved value (e.g., inf, and/or NaN etc.). For example the WTRU may report the preconfigured reserved value based on one or more of CRC failure, failure to determine the post-channel estimate, failure to receive the PDSCH symbols, and/or failure to receive DCI containing the DL allocation, etc. The WTRU may be configured to determine the monitoring metric per layer, for example when the number of layers is greater than 1. The WTRU may be configured to report monitoring metrics, for example per layer, in the monitoring report. The WTRU may report absolute monitoring metric for the (e.g., first) layer and/or for subsequent layers. Additionally, or alternatively, the WTRU may report a differential monitoring metric (e.g., difference between monitoring metric of the (e.g., first) layer and subsequent layers), for example for the subsequent layers. The WTRU may report a monitoring metric for a subset of layers. For example, the WTRU may report monitoring metric for all the layers with a successful CRC.

The WTRU may transmit the monitoring report in L1 uplink control information. In some examples, the WTRU may transmit the monitoring report with (e.g., as a part of) CSI feedback. The WTRU report may be one or more of periodic, semi-persistent, and/or event triggered. For example, the WTRU may be configured with a CSI report quantity that indicates the monitoring reporting type. The WTRU may be configured to transmit a monitoring report based on expiry of a preconfigured timer. In some examples, the WTRU may be configured to transmit a monitoring report periodically (e.g., with a periodicity). The periodicity may be implicitly configured based on the periodicity of a preconfigured reporting resource. In some examples, the WTRU may be configured to transmit a monitoring report periodically, for example where the periodicity may be implicitly configured based on the periodicity of a RS (e.g., DMRS) configured for varying density pattern operation. Additionally, or alternatively, the WTRU may be configured to transmit a monitoring report for every N inferences of the AI model (e.g., for channel prediction model). In some examples, the WTRU may be configured to transmit a monitoring report for every N ms/slots, for example when (e.g., as long as) the associated AI model (e.g., prediction model) is active. The WTRU may be configured to report (e.g., all) the monitoring parameters with a same periodicity. The WTRU may be configured to report different monitoring parameters at different periodicities. Additionally, or alternatively, the WTRU may be configured to transmit the monitoring report as part of HARQ feedback. For example the WTRU may be configured with a HARQ codebook. The HARQ codebook may indicate a subset of codepoints, which for example may indicate implicitly or explicitly a monitoring metric.

The WTRU may transmit the monitoring report in a MAC CE. For example, the WTRU may receive a monitoring report activation and/or deactivation command in a MAC CE. When activated for example, the WTRU may transmit the monitoring report in the MAC CE. The monitoring activation and/or deactivation command may include one or more of a monitoring reporting type, an associated inference model ID/functionality ID, a periodicity, and/or an uplink (UL) resource configuration for reporting, etc.

The WTRU may transmit the monitoring report parameters in a RRC message. For example, the WTRU may receive a configuration for a monitoring report in an RRC reconfiguration message. Additionally, or alternatively, the WTRU may transmit the monitoring report in an RRC reconfiguration complete message. The WTRU may transmit the monitoring report in WTRU assistance information. In some examples, the WTRU may receive a monitoring report configuration in a WTRU information request, for example from a NW. The WTRU may transmit the monitoring report in WTRU information response.

The WTRU may be configured to transmit a monitoring report when one or more preconfigured trigger conditions are satisfied. The WTRU may be configured with one or more (e.g., different) trigger conditions, for example to report the monitoring report (e.g., different monitoring metrics/outcome/parameters). The trigger conditions may be based at least on one or more of a number, a value range, and/or status of a monitoring metric. Additionally, or alternatively, the WTRU may be configured to report monitoring parameters based a change in one or more WTRU-side (e.g., additional) conditions. Example (e.g., additional) conditions may be associated with AI model operation. For example, the WTRU may trigger monitoring reporting based on a change in one or more measurements. Example measurements include one or more of RSRP, RSSI, RSRQ, RI, PMI, CQI, SINR, Doppler spread, Doppler shift, delay spread, average delay, position coordinates, and/or WTRU speed.

The change in the one or more measurements may be relative to one or more previous measurements and/or relative to one or more preconfigured thresholds. For example, the WTRU may trigger a monitoring report when detecting a change from NLOS to LOS or LOS to NLOS. For example, the WTRU may trigger a monitoring report upon a change in one or more of an antenna port configuration, a BWP configuration, an SCell addition/removal, a BWP switch, a beam failure, and/or a beam recovery, etc. In some examples, the WTRU may report a monitoring metric when a fallback and/or model failure is triggered. For example, the WTRU may report a monitoring metric based on the performance of the prediction model. The WTRU may report a monitoring metric based on the performance of the prediction model being above a threshold. Additionally, or alternatively, the WTRU may report a monitoring metric based on the performance of the prediction model being below a threshold. The WTRU may transmit a monitoring report in a configured reporting resource. The reporting resource may be PUCCH or PUSCH. In some examples, the WTRU may transmit a monitoring report in response to a request from a network (e.g., gNB). The WTRU may receive the request in one or more of a DCI, MAC CE, and/or an RRC message.

Systems and methods are provided for DMRS density and pattern selection. A WTRU may be configured to receive a reference signal, for example a, DMRS. The reference signal may have a varying density pattern in time and/or frequency. The WTRU may perform downlink channel processing, for example one or more of demodulation and/or equalization, etc. The WTRU may perform downlink channel processing based on (e.g., as a function of) one or more of a pre-channel estimation (e.g., based on the reference signal), post-detection channel estimation (e.g., based on successfully decoded data symbols), and/or channel prediction (e.g., based on AIML model, based on non-AIML based prediction etc.). The WTRU may receive one or more configuration parameters to perform one or more of hypothetical DMRS generation, and/or selection of DMRS parameters etc.

The WTRU may receive a configuration for one or more (e.g., candidate) hypothetical DMRS patterns. For example, the configuration for the one or more hypothetical DMRS patterns may include one or more of an indication to perform hypothetical DMRS pattern estimation at the WTRU, a set of (e.g., preconfigured) hypothetical DMRS patterns, a set of rule(s) and/or condition(s) for generation of hypothetical DMRS patterns. A set of (e.g., preconfigured) hypothetical DMRS patterns may include (e.g., be defined by) varying densities in time and/or frequency. For example, the hypothetical DMRS pattern may be indexed from a list of predefined time-frequency (2D) pattern and/or a list of time-frequency index pairs of REs within a RB/slot or a group of RB/slots. The WTRU may be configured to select the hypothetical DMRS pattern from the (e.g., preconfigured) hypothetical DMRS patterns. For example, a (e.g., each) hypothetical pattern may be associated with a priority. The WTRU may be configured to select the highest priority DMRS pattern that satisfies the rules for selection of DMRS pattern.

The configuration for the one or more hypothetical DMRS patterns may include a set of rule(s) and/or condition(s) for generation of hypothetical DMRS patterns. The set of rule(s) and/or condition(s) may include one or more of a maximum/minimum density in the frequency domain, a maximum/minimum density/spacing in the time domain, a maximum/minimum spacing in the frequency domain, a maximum/minimum spacing in the time domain, a set of orthogonal cover codes (OCCs), a maximum/minimum number of DMRS in a resource block (RB), a maximum/minimum spacing between RBs containing DMRS, a lowest symbol number within a slot where DMRS can be mapped, and/or a highest symbol number within a slot where DMRS can be mapped.

The set of rule(s) and/or condition(s) may include a maximum/minimum density in the frequency domain. For example, the WTRU may be configured with a maximum/minimum allowed DMRS density in frequency domain (e.g., subcarrier locations within an RB and/or group of RBs). The set of rule(s) and/or condition(s) may include a maximum/minimum density/spacing in the time domain. For example, the WTRU may be configured with a maximum/minimum allowed DMRS density in the time domain (e.g., OFDM symbol locations). The set of rule(s) and/or condition(s) may include a maximum/minimum spacing in the frequency domain. For example, the WTRU may be configured with a maximum/minimum allowed separation between consecutive DMRS in frequency domain (e.g., subcarrier locations within an RB or group of RBs). The set of rule(s) and/or condition(s) may include a maximum/minimum spacing in the time domain. For example, the WTRU may be configured with a maximum/minimum allowed separation between consecutive DMRS in the time domain (e.g., OFDM symbol locations). The set of rule(s) and/or condition(s) may include a set of OCC, for example where the OCC is used to orthogonalize the DMRS resources mapped to the same REs (e.g., for the case of multi-layer transmission). The set of rule(s) and/or condition(s) may include a maximum/minimum number of DMRS in an RB, for example in (e.g., both) the time and/or frequency domain. The set of rule(s) and/or condition(s) may include a maximum/minimum spacing between RBs containing DMRS, for example in (e.g., both) the time and/or frequency domain. Additionally, or alternatively, the set of rule(s) and/or condition(s) may include a lowest symbol number within a slot where DMRS may be mapped and/or a highest symbol number within a slot where DMRS may be mapped.

The WTRU may be configured to determine one or more DMRS parameters, for example based on one or more hypothetical DMRS patterns. For example, the configuration for hypothetical DMRS patterns may include one or more of a distance metric, a maximum allowed distance metric, a maximum/minimum density/spacing in the time and/or frequency domain, and/or a maximum allowed hypothetical BLER. The configuration for hypothetical DMRS patterns may include a distance metric. For example, the distance metric may be configured as one or more of a cosine similarity (e.g., CS, or generalized CS, or squared generalized cosine similarity (SGCS)), a mean squared error (MSE), a normalized mean squared error (NMSE), and/or mean of absolute difference. The configuration for hypothetical DMRS patterns may include a maximum allowed distance metric. For example, the (e.g., maximum allowed) distance may be defined between a pre-channel estimate based on hypothetical DMRS and the post-channel estimate. The configuration for hypothetical DMRS patterns may include a maximum allowed hypothetical BLER for the selection of DMRS parameter(s) among a plurality of hypothetical DMRS patterns, for example based on historical BLER values.

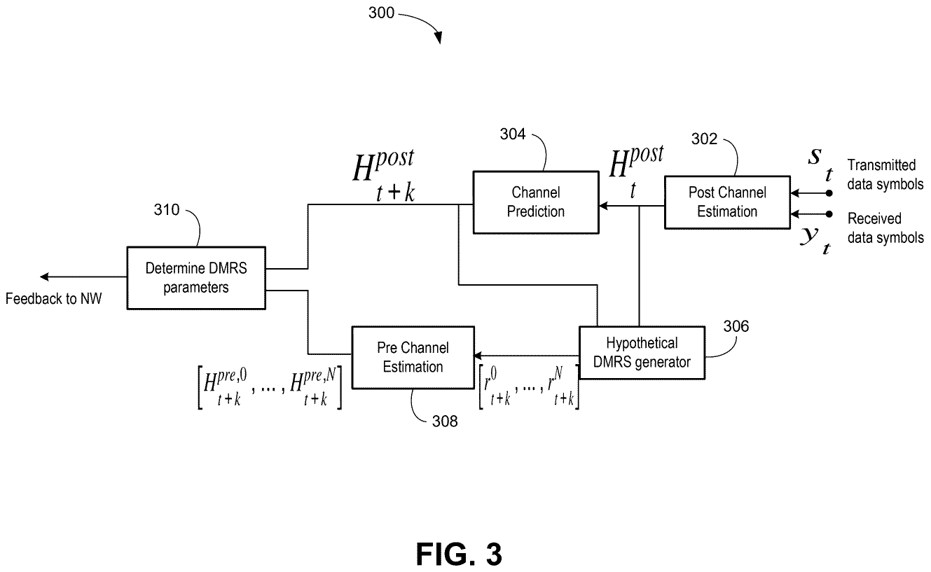

Systems and methods are disclosed for hypothetical DMRS generation. FIG. 3 is a diagram of another example DMRS procedure 300. A WTRU may receive one or more received data symbols. A WTRU may generate hypothetical received DMRS. A WTRU configured to compute and/or report the optimal DMRS density and/or pattern may compute a post-detection channel estimation

$${H}_{t}^{post} ,$$

for example based on the received data symbols yₜ and/or associated decoded transmitted symbols sₜ. The WTRU may compute the post-channel estimation at 302. The WTRU may be additionally or alternatively configured to report the optimal DMRS density and/or pattern (e.g., configuration) for a future time instant t+k. If the WTRU is configured to report predicted DMRS configuration for a future time instant for example, the WTRU may use a channel prediction model (e.g., an AIML model) for the prediction of post-detection channel estimate for a time instant t+k, where k is an integer. The WTRU may perform channel prediction at 304, for example based on the post-channel estimation (e.g., at 302). In some examples channel prediction (e.g., at 304) may be omitted.

The WTRU may generate one or more hypothetical DMRS at 306. For example the WTRU may generate a set of hypothetical received DMRS

$$[ {r}_{t}^{o} , {r}_{t}^{1} , … , {r}_{t}^{N} ] ,$$

where

$${r}_{t}^{i}$$

represents the hypothetical received DMRS signals at time instant t for the ith hypothetical DMRS pattern. The WTRU may generate (e.g., create) the DMRS symbol sequence dᵢ, for example based on a Zhadoff-Chu sequence. The WTRU may apply the associated channel coefficients determined based on the current post-channel estimate

$${H}_{t}^{p o s t}$$

to a DMRS symbol sequence dᵢ, for example for generating a hypothetical received DMRS signal

$${r}_{t}^{i} .$$

For example,

$${r}_{t}^{i} = {d}_{i} {h}_{t , i}^{post} ,$$

where

$${h}_{t , i}^{p o s t}$$

represents the post-channel estimate channel coefficients corresponding to the resource elements in the ith DMRS pattern. The WTRU may apply the associated channel coefficients determined based on the predicted post-detection channel estimate

$${H}_{t + k}^{p o s t}$$

or both

$${h}_{t}^{post} and {h}_{t + k}^{post}$$

to a DMRS symbol dᵢ, for example for generating a hypothetical received DMRS signal for a future time instant

$${r}_{t + k}^{i} .$$

For example,

$${r}_{t + k}^{i} = {d}_{i} {h}_{t + k , i}^{post} ,$$

where

$${h}_{t , i}^{post}$$

represents the predicted post-channel estimate channel coefficients corresponding to the resource elements in the ith DMRS pattern.

Systems and methods are disclosed for hypothetical DMRS density and/or pattern and pre-channel estimation. The WTRU may determine the hypothetical DMRS configuration for the generation of hypothetical DMRS. The hypothetical DMRS configuration may determine (e.g., be used to determine) which resource elements in the resources grid and corresponding post-channel estimation coefficient should be used to generate the hypothetical received DMRS,

$${r}_{t}^{i} .$$

The WTRU may determine the hypothetical DMRS configuration for the generation of hypothetical DMRS based on one or more of a configured and/or indicated set of DMRS patterns, configured rule(s) for hypothetical DMRS pattern generation, and/or post-detection channel estimate(s).

The WTRU may determine the hypothetical DMRS configuration for the generation of hypothetical DMRS based on a configured and/or indicated set of DMRS patterns. The WTRU may use the configured set of DMRS patterns for the generation of the hypothetical DMRS. The hypothetical DMRS patterns may be configured and/or indicated via one or more of RRC, MAC CE and/or DCI. The WTRU may generate a hypothetical DMRS pattern for the configured set of DMRS patterns. The WTRU may determine the hypothetical DMRS configuration for the generation of hypothetical DMRS based on configured rule(s) for hypothetical DMRS pattern generation. The WTRU may be configured with the rule(s) on generating hypothetical DMRS pattern. The WTRU may use one or more of the configured rules to determine the set of hypothetical DMRS configurations/patterns. For example if the WTRU is configured with a maximum/minimum density, the WTRU may (e.g., then) generate (e.g., all) DMRS patterns that satisfy the configured rules. The density of the generated DMRS pattern may be (e.g., always) between the configured minimum and maximum density. For example if the WTRU is additionally or alternatively configured with maximum/minimum spacing between the DMRS in the grid, the WTRU may down select the DMRS pattern that satisfies the configured maximum/minimum spacing criteria.

The WTRU may determine the hypothetical DMRS configuration for the generation of hypothetical DMRS based on a post-detection channel estimate. The WTRU may be configured to determine hypothetical DMRS configurations for DMRS pattern generation, based on the calculated post-channel estimate. The WTRU may determine locations of REs in the resource grid for DMRS mapping. The WTRU may determine the locations of REs where the post-channel coefficient in the corresponding RE shows a high degree of change (e.g., wrt to a threshold), for example compared to the channel coefficients of neighbouring REs. For example, the WTRU may determine the locations of REs where the magnitude of the post-channel coefficient in the corresponding RE is higher than the magnitude of the channel coefficients of the neighbouring REs. The WTRU may determine the locations of REs where the magnitude of the post-channel coefficient in the corresponding RE is lower than the magnitude of the channel coefficients of the neighbouring REs. The WTRU may generate hypothetical DMRS patterns based on the combinations determined RE locations for DMRS. In some examples, the WTRU may use a predicted post-channel estimate computed for a future time index t+k and/or compute the hypothetical DMRS patterns for the future time index.

Systems and methods are discloses for DMRS parameter selection and reporting. The WTRU may perform a pre-channel estimation at 308. For example, a WTRU may select one or more DMRS parameters. The WTRU may compute the pre-channel estimates

$$[ {H}_{t}^{p r e , 0} , … , {H}_{t}^{pre , N} ] ,$$

for example using on the hypothetical received DMRS

$$[ {r}_{t}^{o} , {r}_{t}^{1} , … , {r}_{t}^{N} ]$$

generated based on the hypothetical DMRS patterns [d₀, . . . , d_{N}]. If the WTRU is configured to report DMRS for future instances t+k for example, the WTRU may (e.g., then) compute the pre-channel estimates

$$[ {H}_{t + k}^{p r e , 0} , … , {H}_{t + k}^{pre , N} ]$$

using on the hypothetical received DMRS

$$[ {r}_{t + k}^{o} , {r}_{t + k}^{1} , … , {r}_{t + k}^{N} ]$$

generated based on the hypothetical DMRS patterns [d₀, . . . , d_{N}].

The WTRU may compute a metric measuring the difference between the pre-channel estimates

$$[ {H}_{t}^{pre , 0} , … , {H}_{t}^{pre , N} ]$$

and post-detection channel estimate

$${H}_{t}^{post} , e . g . , {D}_{i} = D i s t ( {H}_{t}^{pre , i} , {H}_{t}^{post} ) .$$

In case of future time instances for example, the WTRU may compute a metric measuring the difference between the pre-channel estimates

$$[ {H}_{t + k}^{pre , 0} , … , {H}_{t + k}^{pre , N} ] and {H}_{t + k}^{post} .$$

For example, the distance metric may be one or more of a squared generalized cosine similarity (SGCS) and/or normalized mean square error (NMSE), for example based on the configuration.

The WTRU may receive configuration information (e.g., a configuration) on determining the optimal DMRS pattern (e.g., threshold on maximum allowed distance, maximum and minimum density, and/or historical BLER thresholds). The WTRU may determine the optimal DMRS pattern based on one or more of on the maximum distance threshold and configured minimum density, the distance metric, and/or the configured BLER thresholds.

The WTRU may determine the optimal DMRS pattern based on the maximum distance threshold and configured minimum density. For example, the WTRU may select the DMRS pattern with minimum DMRS density that satisfies the maximum distance threshold. If there are more than one DMRS pattern that satisfy the criteria for example, the WTRU may (e.g., then) select the DMRS pattern with minimum distance. The WTRU may determine the optimal DMRS pattern based on the distance metric. For example, the WTRU may select the DMRS density with minimum distance metric (e.g., regardless of any constrains/configurations on density for DMRS parameter selection). The WTRU may determine the optimal DMRS pattern based on the configured BLER thresholds. For example if the historical BLER exceeds a configured threshold, the WTRU may (e.g., then) select a DMRS pattern with a higher density than the previous determined DMRS pattern. The determined DMRS parameters may be same for one or more (e.g., all) resource blocks/slots. For example the same pattern may be applied to every resource block/slot. In some examples, the WTRU may determine DMRS parameters separately for subsets of time/frequency/space resources.

Systems and methods are disclosed for reporting one or more selected DMRS density. The WTRU may determine one or more DMRS parameters at 310. The WTRU may determine the one or more DMRS parameters (e.g., at 310) based on one or more of the channel prediction (e.g., at 304), the pre-channel estimation (e.g., at 308), and/or the generated one or more hypothetical DMRS (e.g., at 306). The WTRU may report the determined DMRS parameters based on the reporting configuration, and/or based on one or more of an index, a position of DMRS, a (e.g., different) DMRS parameter, and/or a BLER target. The WTRU may report the determined DMRS parameters to the network, for example as feedback.

The WTRU may report an index corresponding to the determined DMRS parameters, for example where the index may be selected from a codebook of DMRS parameters. The codebook of DMRS parameters may be pre-configured to the WTRU. The WTRU may report the positions of DMRS in the determined DMRS pattern, for example where the positions may correspond to position of REs in resource grid. In some examples the WTRU may report the determined DMRS parameters after a (e.g., every) post-channel estimation. The WTRU may report the determined DMRS parameters, for example if the density of the determined DMRS parameters is higher than or lower than the previously reported DMRS parameters. The WTRU may compute the difference between the densities of the current and previous reported DMRS densities. The WTRU may report the determined DMRS parameters, for example if the absolute value of the difference is higher than a threshold. The WTRU may report the determined DMRS parameters based on a BLER target. For example if the historical BLER is above a threshold, the WTRU may (e.g., then) report the determined DMRS parameters.

A WTRU may receive DMRS based on a temporal density pattern. The WTRU may equalize, for example based on a channel prediction computed using decoded data symbols. The WTRU may report a channel prediction metric. The WTRU may be configured to (e.g., capable of) channel prediction with post-channel estimation. The WTRU may receive configuration information. The configuration information may include and/or be for one or more of multiple DMRS configurations (e.g., DMRS_config #1, DMRS_config #2, etc.), rules to determine a DMRS configuration, channel prediction performance metrics for feedback, channel prediction model configuration, model monitoring metrics, a reporting periodicity for prediction performance metric(s), a reporting periodicity for model monitoring, DMRS prediction timing, and/or DMRS prediction reset. The rules to determine the DMRS configuration may enable a temporal (e.g., gradually reducing density) DMRS pattern.

The WTRU may receive a (e.g., first) DMRS, rₜ, for example based on a (e.g., first) DMRS configuration. The DMRS configuration (e.g., configuration information) may be based on and/or include one or more of a slot number, a time difference between a current and a previous slot in which the PDSCH was received and/or a corresponding DMRS configuration, an indication in DCI to detect the DMRS configuration, and/or an indication of whether an associated transmission is a transmission of new data or a retransmission. The indication in DCI may be implicit (e.g., reuse DAI) or explicit (e.g., a new indication).

The WTRU may receive a (e.g., first) set of associated transmission data symbols, yₜ. The WTRU may determine (e.g., compute) a (e.g., first) predicted channel

$${H}_{t}^{pred} ,$$

for example based on the DMRS prediction timing and/or the received (e.g., first) DMRS. For example if DMRS prediction timing t=0 and/or there is a DMRS prediction reset for the (e.g., first) DMRS configuration, the WTRU may determine that the first predicted channel

$${H}_{t}^{pred} .$$

is the same as a first DMRS-based channel estimation

$$( e . g . , {H}_{0}^{pre} ,$$

determined from the received first DMRS). For example if DMRS prediction timing t>0 for the (e.g., first) DRMS configuration, the WTRU may compute the (e.g., first) predicted channel,

$${H}_{t}^{p r e d} .$$

The WTRU may determine (e.g., compute) the (e.g., first) predicted channel using one or more of the (e.g., first) DRMS-based channel estimation,

$${H}_{t}^{p r e}$$

and/or one or more (e.g., first) post-channel estimates

$$( e . g . , {H}_{t - x}^{post} , 1 \leq x \leq t ) .$$

The WTRU may compute a (e.g., first) set of equalized received symbols,

$${y}_{t}^{e q} ,$$

for example based on one or more of the received DMRS, the received data symbols, and/or the (e.g., first) predicted channel

$${H}_{t}^{p r e d} .$$

The WTRU may decode a (e.g., first) set of data bits aₜ, for example based on the first set of equalized received symbols.

The WTRU may compute a (e.g., second) post-detection channel estimate,

$${H}_{t}^{post} ,$$

for example based on the decoded (e.g., first) set of data bits and/or whether the decoding passes CRC. The WTRU may compute a (e.g., first) set of decoded symbols, sₜ, using the (e.g., first) set of decoded data bits aₜ, for example if CRC pass after decoding. Additionally, or alternatively, the WTRU may encode a codeword, for example depending on the channel coding scheme. The WTRU may compute the (e.g., second) post-detection channel estimate

$${H}_{t}^{post}$$

using the (e.g., first) set of decoded data symbols sₜ and/or (e.g., first) set of received data symbols yₜ, for example if CRC pass after decoding.

The WTRU may use the (e.g., first) set of decoded data bits at and/or compute the (e.g., second) post-detection channel estimate

$${H}_{t}^{p o s t} ,$$

for example if CRC fail after decoding (e.g., similar to if CRC had passed). The WTRU may select a subset of the (e.g., first) set of decoded data bits,

$${a}_{t}^{′} ,$$

by excluding bits with high error probability and/or compute the (e.g., second) post-detection channel estimate

$${H}_{t}^{p o s t}$$

using the subset of the (e.g., first) set of decoded data bits and/or the procedure described for when CRC passes, for example if CRC fail after decoding. The WTRU may set the (e.g., second) post-detection channel estimate to be a (e.g., previously computed) (e.g., first) post-detection channel estimate, for example if CRC fail after decoding. (e.g., computed for a case where CRC passed). For example,

$${H}_{t}^{p o s t} ← {H}_{t - 1}^{p o s t} .$$

The WTRU may determine that there is no (e.g., second) post-detection channel estimate, for example if CRC fail after decoding.

The WTRU may compute a prediction and/or monitoring metric, for example based on one or more (e.g., (e.g., first)) predicted channel(s)

$${H}_{t}^{pred}$$

and/or one or more (e.g., (e.g., second)) post-detection channel estimate(s)

$${H}_{t}^{p o s t} .$$

The prediction and/or monitoring metric may include a distance metric between a predicted channel and a post-channel estimate. The distance metric may include one or more of a cosine similarity (e.g., SGCS metric), a mean squared error (e.g., NMSE metric), and/or a mean absolute difference. For a number of layers greater than 1 for example, the WTRU may compute one or more of a distance metric per layer, a distance metric for a subset of layers, a differential distance metric per layer, and/or a distance metric based on the CRC failure per layer.

The WTRU may compute a metric, for example every P predicted channel instance. The metric may include one or more of a measure of distances between

$${H}_{t}^{pre} and {H}_{t}^{pred} ,$$

a measure of distances between

$${H}_{t}^{p r e} and {H}_{t}^{p o s t} ,$$

a mean or distance (e.g., Dist(·)) for P historical instances, a standard deviation (stdev) of distance (e.g., Dist(·)) for P historical instances, and/or a distance (e.g., Dist(·)) for each P historical instances.

The WTRU may transmit a prediction and/or monitoring metric report, for example based on a configured reporting periodicity. The report may include one or more of a computed metric, an indication of whether the distance metric meets configured criteria, an indication (e.g., report 1 (0)) when the distance metric is above or below a (e.g., configured) threshold, and/or a distance metric. For example the report may include a distance metric when the distance metric is above a threshold. The WTRU may report a value indicating the failure (e.g., inf, or report nan), for example if there is a CRC fail. If the number of layers greater than 1 for example, the WTRU may report one or more of a distance metric per layer, a differential distance between layers, a distance metric for a subset of layers. The WTRU may report based on (e.g., depending on) CRC failures per layer.

Systems and methods may reduce DMRS overhead using decoded data symbols for equalization. The WTRU may determine a DMRS pattern with a lowest density, for example using decoded data symbols. A WTRU configured to (e.g., capable of) perform post-channel estimation and/or hypothetical DMRS generation may receive configuration information. The configuration information may include and/or be for a configuration on hypothetical DMRS generation. The configuration on hypothetical DMRS generation may include one or more of a set of hypothetical DMRS patterns, rule(s) for hypothetical DMRS generation, and/or an indication to determine the hypothetical DMRS at the WTRU. The rule(s) for hypothetical DMRS generation may include one or more of maximum/minimum density, maximum/minimum number of DMRS, maximum/minimum spacing between DMRS in the grid, and/or maximum/minimum number of DMRS patterns.

The configuration information may include and/or be for a configuration on the selection of DMRS parameters (e.g., density and/or pattern). The configuration on the selection of DMRS parameters may include rule(s) for determining the DMRS parameters and/or a distance metric for DMRS parameter selection. The rule(s) for determining the DMRS parameters may include one or more of a threshold on maximum allowed distance metric, a max/min density, and/or be based on historical BLER thresholds. For example, the WTRU may be configured with a rule to report a higher DMRS density for BLER higher than the threshold.

The WTRU may generate hypothetical DMRS for pre-channel estimation, for example based on one or more of configured/indicated set of DMRS patterns, rule(s) for hypothetical DMRS generation, a post-channel estimate, and/or based on a future time index. For example, the WTRU may use the configured/indicated set of DMRS patterns to generate the hypothetical DMRS. The WTRU may generate set of hypothetical DMRS patterns that satisfy all the configured rules. The WTRU may determine a set of hypothetical DMRS by processing the transmitted and/or received symbols, for example for the post-channel estimate. For example, the WTRU may compute the RE(s) with highest degree of change. The WTRU may predict the channel for a future time index t+k and/or compute the hypothetical DMRS for the future time index.

The WTRU may compute post-channel estimation using the decoded data symbols and/or received data symbols. The WTRU may compute the distance between post-detection channel estimate and all pre-channel estimates. The WTRU may determine the DMRS parameters based one or more of the DMRS pattern and/or density that satisfies the distance threshold with minimum density, and/or the DMRS pattern and/or density with lowest distance metric. The WTRU may report the (e.g., selected) DMRS parameters by reporting a DMRS density and/or pattern. For example, the WTRU may report the DMRS density and/or pattern after every post-channel estimation. The WTRU may report the DMRS density and/or pattern (e.g., only) if a computed density is higher or lower than the previous reported density. The WTRU may report the DMRS density and/or pattern based on a BLER target. Systems and methods as herein may result in optimal DMRS density/pattern selection via hypothetical DMRS generation at the WTRU.

1. A wireless transmit/receive unit (WTRU) comprising:
a processor, the processor configured to:
receive configuration information for a plurality of demodulation reference signals (DMRSs), wherein each of the plurality of DMRSs comprises a respective density;
receive a first DMRS of the plurality of DMRSs based on the configuration information;
determine a pre-channel estimation based on the first DMRS of the plurality of DMRSs;
determine a post-channel estimation;
predict a first channel based on the pre-channel estimation and the post-channel estimation; and
send an indication of a distance between the predicted first channel and the post-channel estimation to a network.

2. The WTRU of claim 1, wherein the processor is configured to:
receive first symbols from the network; and
determine the post-channel estimation based on the first symbols.

3. The WTRU of claim 1, wherein the respective densities of each of the plurality of DMRSs comprise different densities.

4. The WTRU of claim 1, wherein the processor is configured to:
receive first data symbols from the network; and
equalize the received first data symbols based on the predicted first channel.

5. The WTRU of claim 4, wherein the processor is configured to:
decode the equalized first data symbols to obtain bits;
convert the bits to second symbols; and
determine the post-channel estimation based on the first symbols and on the second symbols.

6. The WTRU of claim 1, wherein the processor is configured to send feedback to the network, the feedback associated with the plurality of DMRSs, and the feedback comprising an indication of a distance metric between the predicted first channel and the post-channel estimation.

7. The WTRU of claim 1, wherein the processor is configured to send feedback to the network, the feedback associated with the predicted first channel, and the feedback comprising an indication of a distance metric between the pre-channel estimation and the predicted first channel.

8. The WTRU of claim 7, wherein the indication comprises an indication of whether the difference between the pre-channel estimation and the predicted first channel exceeds a threshold.

9. The WTRU of claim 1, wherein the processor is configured to:
perform a cyclic redundancy check (CRC);
determine that the CRC has failed, wherein the processor is configured to predict the first channel based on the pre-channel estimation.

10. The WTRU of claim 1, wherein the processor is configured to:
perform a cyclic redundancy check (CRC);
determine that the CRC has passed, wherein the processor is configured to predict the first channel based on the post-channel estimation.

11. A method implemented by a wireless transmit/receive unit (WTRU), the method comprising:
receiving configuration information for a plurality of demodulation reference signals (DMRSs), wherein each of the plurality of DMRSs comprises a respective density;
receiving a first DMRS of the plurality of DMRSs based on the configuration information;
determining a pre-channel estimation based on the first DMRS of the plurality of DMRSs;
determining a post-channel estimation;
predicting a first channel based on the pre-channel estimation and the post-channel estimation; and
sending an indication of a distance between the predicted first channel and the post-channel estimation to a network.

12. The method of claim 11, comprising:
receiving first symbols from the network; and
determining the post-channel estimation based on the first symbols.

13. The method of claim 11, wherein the respective densities of each of the plurality of DMRSs comprise different densities.

14. The method of claim 11, comprising:
receiving first data symbols from the network; and
equalizing the received first data symbols based on the predicted first channel.

15. The method of claim 14, comprising:
decoding the equalized first data symbols to obtain bits;
converting the bits to second symbols; and
determining the post-channel estimation based on the first symbols and on the second symbols.

16. The method of claim 11, comprising sending feedback to the network, the feedback associated with the plurality of DMRSs, and the feedback comprising an indication of a distance metric between the predicted first channel and the post-channel estimation.

17. The method of claim 11, comprising sending feedback to the network, the feedback associated with the predicted first channel, and the feedback comprising an indication of a distance metric between the pre-channel estimation and the predicted first channel.

18. The method of claim 17, wherein the indication comprises an indication of whether the difference between the pre-channel estimation and the predicted first channel exceeds a threshold.

19. The method of claim 11, comprising:
performing a cyclic redundancy check (CRC);
determining that the CRC has failed; and
predicting the first channel based on the pre-channel estimation.

20. The method of claim 11, comprising:
performing a cyclic redundancy check (CRC);
determining that the CRC has passed; and
predicting the first channel based on the post-channel estimation.
